(19) United States
(12) Patent Application Publication
(10) Pub. No.: US 2005/0063002 A1
(43) Pub. Date: Mar. 24, 2005

(54) Recording medium recording program for print job encryption

(75) Inventor: Yoshinori Sugahara, Kyoto-shi (JP)

Correspondence Address: BURNS DOANE SWECKER & MATHIS L L P, POST OFFICE BOX 1404, ALEXANDRIA, VA, 22313-1404, US

(73) Assignee: KONICA MINOLTA BUSINESS TECHNOLOGIES, INC.

(21) Appl. No.: 10/740,505

(22) Filed: Dec. 22, 2003

(30) Foreign Application Priority Data
Sep. 22, 2003 (JP) 2003-329322

(51) Int. Cl. G06F 15/00; H04L 9/00

(52) U.S. Cl. 358/1.15; 713/150

(57) ABSTRACT

In a printer driver of a personal computer, only a text portion of a print job is encrypted by using an encryptor, to have an encrypted print job. The personal computer and a printer share a plurality of encryption techniques. A technique used for encryption is determined through negotiation between the personal computer and the printer. In the personal computer and the printer, it is possible to register an original encryption technique that corresponds to a user ID. By this configuration, it becomes possible to keep contents of the print job concealed from others.

This application is based on Japanese Patent Application No. 2003-329322 filed with Japan Patent Office on Sep. 22, 2003, the entire content of which is hereby incorporated by reference.

### BACKGROUND OF THE INVENTION

1. Field of the Invention

The present invention relates to a recording medium recording a print job processing program, a printing device and a printing system and, more specifically, to a recording medium recording a print job processing program, a printing device and a printing system that are capable of improving data security by encrypting the print job.

2. Description of the Related Art

Conventionally, in the field of printing devices represented by an MFP (Multi Function Peripheral), a facsimile device or a printer, a printing device has been known that has a function of withholding printing unless a password input to a host PC (personal computer) is also input to the printing device, so as to protect the object of printing.

As described above, in the field of printing devices, it has become a general practice to provide a function of keeping the contents of printing confidential, or secret from a third party, for tighter security. On the other hand, such devices become more and more popular that temporarily hold data for printing in a server or the like when data obtained through the Internet, for example, is to be printed.

It is particularly noted that a character string portion (text portion) of a print job is often described by a general code referred to as TEXT CODE, and if the print job should be analyzed by using a general TEXT CODE table on a transmission path of the print job (for example, a printer server or a mail server), the contents of the printing could be read by a third party.

In order to solve such a problem, Japanese Laid-Open Patent Publication No. 9-134264 discloses a system in which a printer is inquired of an encryption key through a network, encryption is performed using the encryption key sent from the printer, and the encrypted print job and the encryption key are transmitted to the printer.

Japanese Laid-Open Patent Publication No. 2002-344440 discloses a system in which the encryptor is inquired of the encryption key, and a definite group of encryption techniques is used.

### SUMMARY OF THE INVENTION

An object of the present invention is to provide a print job processing program, a printing device and a printing system that enhances security of a print job and are highly convenient for the user.

In order to attain the above described object, the present invention provides, according to an aspect, a recording medium recording a print job processing program for transmitting print data to an external device, to have a computer execute an encrypting step of identifying and encrypting a text portion of an input print job; and a transmission step of transmitting the print job having the text portion encrypted by the encrypting step to an external device.

According to another aspect of the present invention, the recording medium recording a print job processing program used in a device having a storage area storing an encryption technique common to an encryption technique performed by an external device has a computer execute an input step of inputting a new encryption technique; a registering step of registering the input new encryption technique in the storage area; and a transmission step of transmitting the input new encryption technique to the external device so that said input new encryption technique is registered in said external device.

According to a further aspect, the present invention provides a printing device including a decryptor identifying a text portion from an input print job and decrypting that text portion; and a printer printing the print job having the text portion decrypted by the decryptor.

According to a still further aspect, the present invention provides a printing device including a receiver receiving a new encryption technique together with a user ID; a registry registering the received encryption technique as a new encryption technique in correspondence with the user ID; a selector selecting one of a plurality of registered encryption techniques based on a user ID that corresponds to a print job, when the print job is to be processed; a decryptor decrypting the print job using the selected encryption technique; and a printer printing the print job decrypted by the decryptor.

According to a still further aspect, the present invention provides a printing system having a computer and a printing device connected to a network, wherein the computer includes an allocater allocating a job ID to a print job, a first transmitter transmitting the job ID to the printing device, a receiver receiving information identifying an encryption technique transmitted by the printing device in response to transmission by the first transmitter, an encryptor selectively encrypting a text portion of the print job in accordance with the received information identifying the encryption technique, and a second transmitter transmitting the encrypted print job to the printing device; and the printing device includes a first receiver receiving the job ID from the computer, a selector selecting the encription technique in response to reception by the first receiver, a transmitter transmitting information identifying the selected encryption technique to the computer, a second receiver receiving the print job encrypted by the selected encryption technique from the computer, and a decryptor selectively decrypting the text portion of the received encrypted print job by the selected encryption technique.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of a printing system in accordance with a first embodiment of the present invention.

FIG. 2 is a block diagram representing a hardware configuration of an MFP 100 shown in FIG. 1.

FIG. 3 is a block diagram representing a hardware configuration of host PCs 300a and 300b shown in FIG. 1.

FIG. 4 represents a process performed by a host PC and MFP in the printing system shown in FIG. 1.

FIG. 5 shows a specific example of an encryption table as one encryption technique among a group of encryption techniques.

FIG. 6 is a flow chart representing a process performed by a host PC and MFP in accordance with the first embodiment.

FIG. 7 represents a process performed at the time of registering an encryption technique, by the printing system in accordance with a second embodiment.

FIG. 8 is a flow chart representing a process performed by a host PC and MFP in a new encryption technique registering process shown in FIG. 7.

FIG. 9 represents processes performed by a host PC and MFP at the time of printing in accordance with the second embodiment.

FIG. 10 is a flow chart representing a process performed by a host PC and MFP in accordance with the second embodiment.

### DESCRIPTION OF THE PREFERRED EMBODIMENTS

A printing system in accordance with a preferred embodiment of the present invention will be described in detail with reference to the figures.

In the printing system in accordance with the present embodiment, a print job is transmitted from a host PC through a network to a printing device and printed therein. The printing system is characterized in that only the character (text) portion of the print job is encrypted to keep the contents of printing secret from a third party.

Specifically, both at the host PC and the printing device, common plurality of encryption techniques are prepared. A negotiation is conducted in advance between the host PC and the printing device as to which encryption technique is to be used. Using the encryption technique determined by the negotiation, only the TEXT CODE of the print job to be output to the transmission path is encrypted. Thus, it becomes impossible for a third party to identify the encryption technique, and hence, print job security can be enhanced.

### First Embodiment

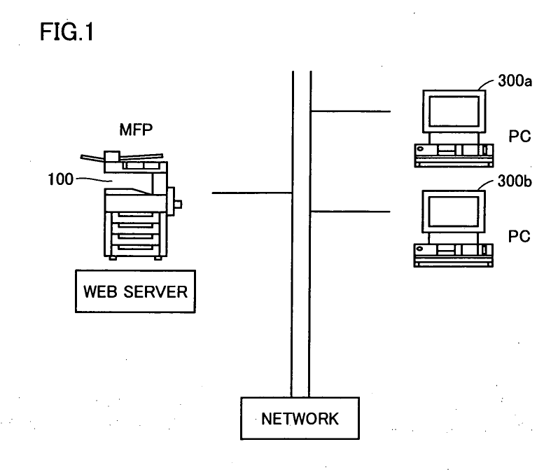

Referring to FIG. 1, the present system includes an MFP 100 (MFP 100 also functions as a Web server) and host PCs (personal computers) 300a and 300b connected to a network.

Data to be printed obtained by scanning an original set in MFP 100, data to be printed transmitted from host PC 300a or 300b through the network to MFP 100, or data to be printed transmitted to MFP 100 externally from a public circuit is temporarily stored in a storage device such as a hard disk in MFP 100. Using the stored data, printing is done by MFP 100.

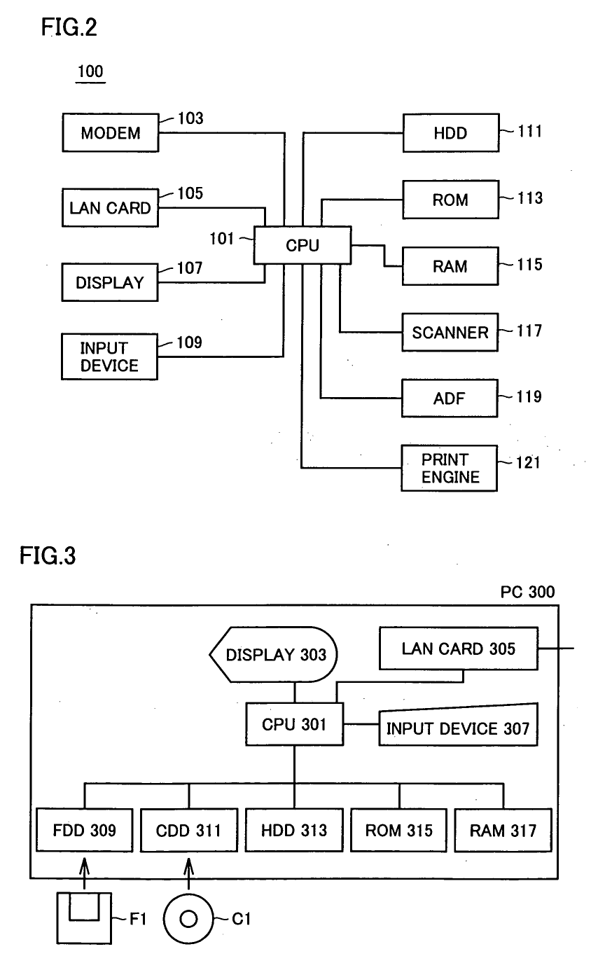

FIG. 2 is a block diagram representing a hardware configuration of MFP 100 shown in FIG. 1.

Referring to the figure, MFP 100 includes a CPU 101 for overall control, a modem 103 for connection to a general public circuit, a Local Area Network (LAN) card 105 for connection to the Internet or a LAN, a display 107 displaying necessary information for the user, an input device 109 represented by keys and the like for inputting information necessary for the operation of the device from a user, a hard disk 111 storing data to be printed and the like, a ROM 113 for storing a program and the like, a RAM 115 for temporarily storing data, a scanner 117 for reading an original, an automatic document feeder (ADF) 119, and a print engine 121 for printing image data.

FIG. 3 is a block diagram representing a hardware configuration of one of the host PCs 300a and 300b of FIG. 1.

Referring to the figure, the host PC includes a CPU 301 for overall control, a display 303, a LAN card for connection to the LAN, an input device 307 represented by a keyboard or a mouse, a flexible disk drive (FDD) 309, a CD-ROM drive (CDD) 311, a hard disk drive (HDD) 313, a ROM 315, and a RAM 317.

Flexible disk drive 309 allows reading of image data or program recorded on a flexible disk (F1), and CD-ROM drive 311 allows reading of image data or program recorded on a CD-ROM (C1).

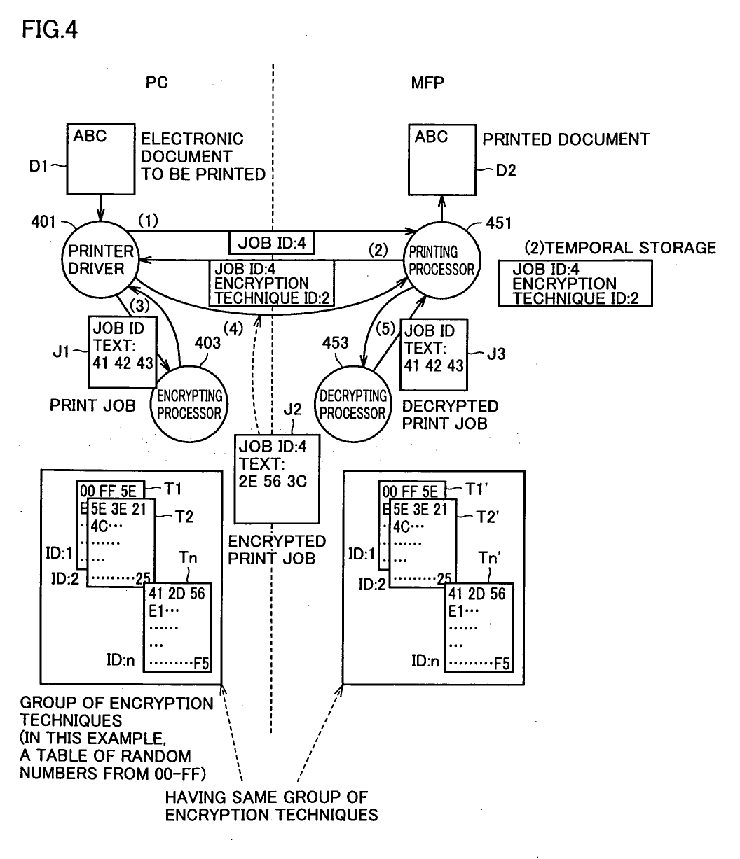

FIG. 4 represents a process performed by the host PC and the MFP in the printing system shown in FIG. 1.

Referring to FIG. 4, the host PC (left side on the figure) includes a printer driver 401, an encryption processor 403 and a group of encryption techniques. Specifically, these are implemented by software that operates CPU 301 recorded on RAM 317 or the like, or data recorded on RAM 317 or the like. Such software and data are recorded, for example, on the hard disk, and read to the RAM. Further, MFP (right side on the figure) includes a printing processor 451, a decrypting processor 453 and a group of encrypting techniques. Specifically, these are implemented by software for operating the CPU 101 recorded on RAM 115 or the like, data recorded on RAM 115 or the like, or print engine 121. Such software or data is recorded on a ROM or an EEPROM (Electrically Erasable and Programmable ROM), and read to the RAM.

Referring to FIG. 4, an example will be described in which an electronic document D1 to be printed is transmitted as a print job from the host PC to the. MFP and printed out as a printed document D2 on the MFP.

At this time, the following processes are performed by the host PC and the MFP.

(1) Electronic document D1 to be printed is input to printer driver 401 provided in the host PC. Printer driver 401 determines a job ID of an arbitrary value, and transmits a request for an encryption technique to the MFP together with the job ID (see (1) in the figure). Here, it is assumed that the job ID is 4.

(2) Receiving the job ID, printing processor 451 of the MFP selects an encryption technique ID (any of 1 to n) for specifying the encryption technique at random or in accordance with a prescribed rule among a plurality of encryption techniques T1′ to Tn′ (here, it is assumed that “2” is selected as the encryption ID), and holds the combination of the job ID and the encryption technique ID until printing of the job ends. At the same time, the selected encryption ID is returned together with the job ID, to printer driver 401 (see (2) in the figure).

(3) The same encryption techniques T1 to Tn as the plurality of encryption techniques T1′ to Tn′ recorded on the MFP are also registered on the side of the host PC. Printer driver 401 performs encryption of only the text portion of print job J1 using the encryption technique designated by the ID from the MFP, to provide encrypted print job J2 (see (3) in the figure).

(4) The encrypted print job J2 is transmitted together with the job ID to the MFP (see (4) in the figure).

(5) Based on the job ID, printing processor 451 reads the corresponding encryption technique ID that has been saved in the process (2) above, and using the encryption technique, decrypts only the text portion of the encrypted print job J2 at decrypting processor 453, to prepare decrypted print job J3 (see (5) in the figure).

(6) The decrypted print job J3 is printed by printing processor 451, and output as printed document D2.

Even when a drawing, a photograph or the like is included in the electronic document D1 to be printed, encrypting processor 403 selectively encrypts only the text (characters) portion thereof Further, decrypting processor 453 selectively decrypts only the encrypted text portion. Thus, it becomes possible to reduce the time necessary for the encrypting and decrypting operations while enhancing confidentiality of the text portion of the print job.

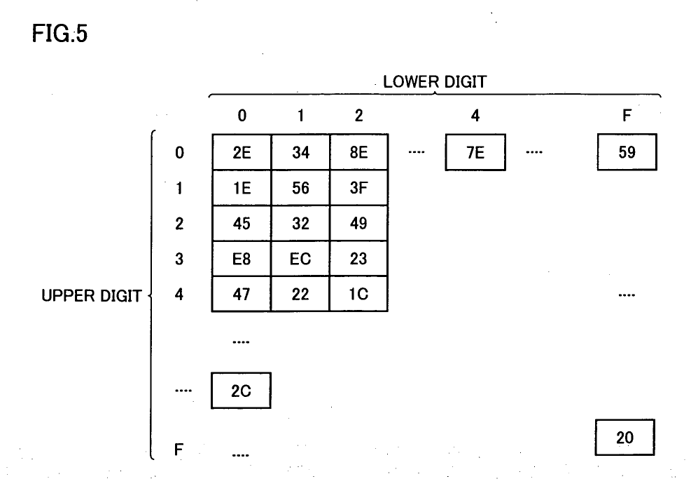

FIG. 5 represents a specific example of the encryption table as one of the encryption techniques included in the group.

As can be seen from FIG. 5, a table having 256 encryption values from “00” to “FF” (in hexadecimal notation) arranged at random is used as the encryption table.

When the text to be encrypted is assumed to be “AB”, these will be “41” and “42” (in hexadecimal notation) on the character code. On the encryption table, encryption values corresponding to the positions of the character code are obtained. In this example, the upper digit of “41” is “4” and the lower digit is “1”, and hence, the encrypted value in accordance with the table of FIG. 5 will be “22” (in hexadecimal notation). By an exclusive OR of this encrypted value and “41” (in hexadecimal notation) of the character code, an encrypted text code is provided.

By way of example, the encrypted text code of “41” (in hexadecimal notation) will be “63” (in hexadecimal notation), and the character string “AB” will be “63” and “5E” (in hexadecimal notation).

For decryption, through the procedure reverse to that for encryption, the character string “AB” can be recovered from the encrypted text code.

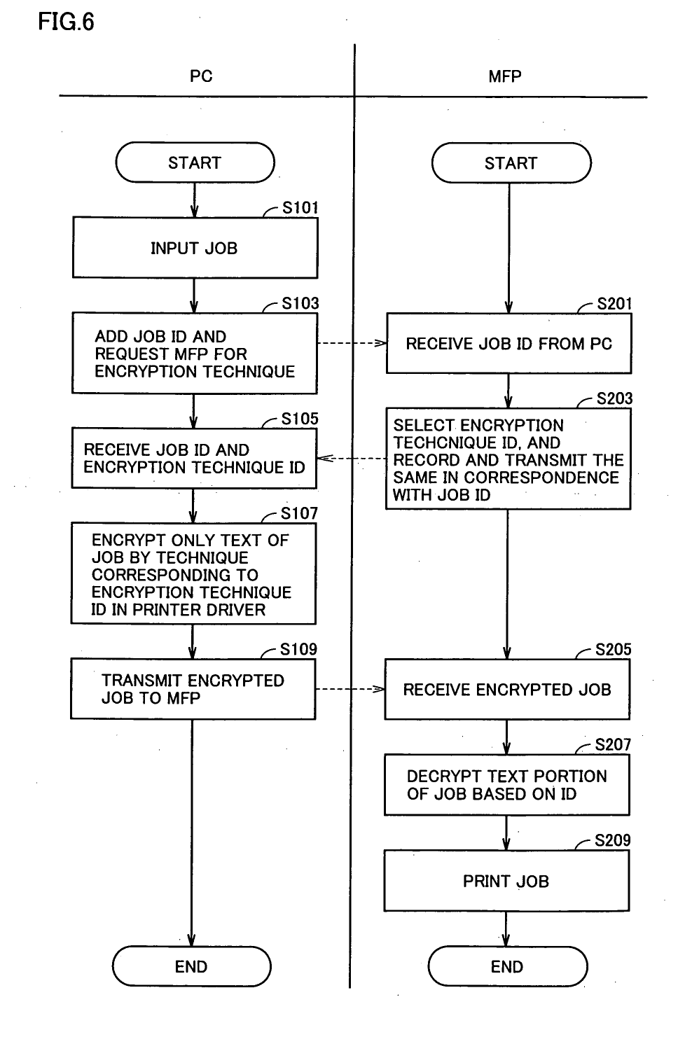

FIG. 6 is a flow chart representing the process performed by the host PC and the MFP in accordance with the present embodiment.

Referring to the figure, in the host PC, a print job is input in step S101. In step S103, ajob ID is added to the print job, and a request for encryption technique is issued to the MFP.

In step S105, the job ID and an encryption technique ID are received from the MFP.

In step S107, by a technique corresponding to the encryption technique ID, only the text of the print job is encrypted by the printer driver, and in step S109, the thus encrypted job is transmitted to the MFP.

In the MFP, when the job ID is received from the host PC in step S201, the encryption technique ID is selected in step S203 and recorded in correspondence with the job ID. Further, the job ID and the selected encryption technique ID are transmitted to the host PC.

When the encrypted job is received from the host PC in step S205, the encryption technique ID is identified based on the job ID of the received job in step S207, and only the text portion of the job is decrypted. After decryption, the job is printed in step S209.

### Second Embodiment

The hardware configuration of the printing system in accordance with the second embodiment is the same as that of the first embodiment, and therefore, description thereof will not be repeated here. In the second embodiment, as the group of encryption techniques, a plurality of table containing techniques unique to the transmitter of the print job are prepared, and for every printing, the encryption technique used is determined through negotiation between the host PC and the printing device. Accordingly, data security can further be enhanced than in the first embodiment. Specifically, in the present embodiment, a plurality of groups of encryption techniques are stored for each user ID, in the MFP.

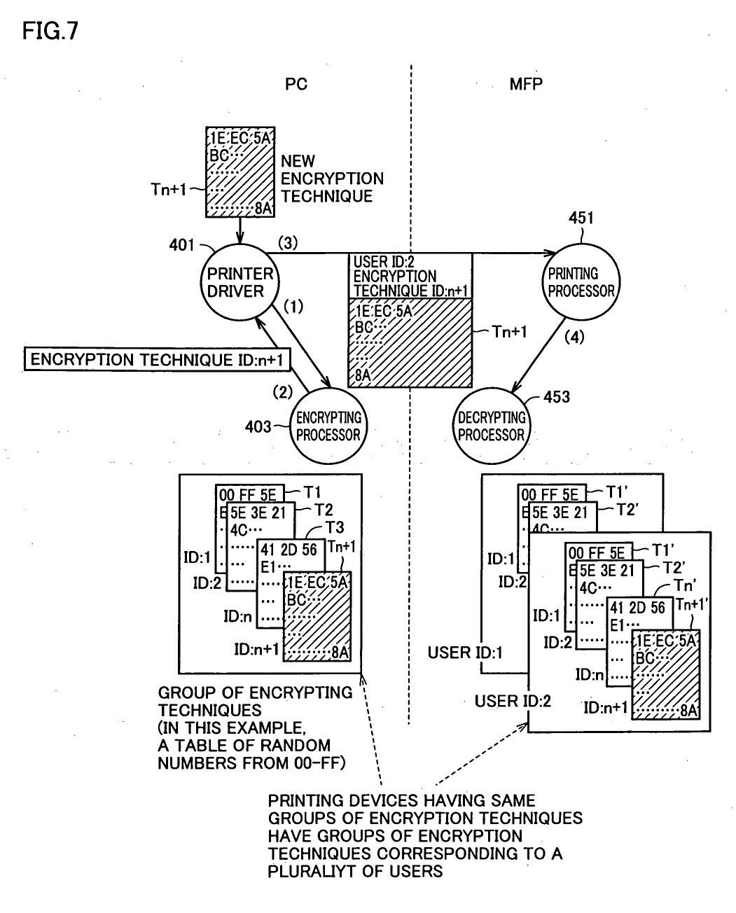

FIG. 7 represents a process performed by the printing system in accordance with the second embodiment of the present invention when the encryption technique is registered.

Referring to the figure, in the MFP, a group of encryption techniques for user ID:1 and a group of encryption techniques for user ID:2 are recorded separately.

It is possible for a user to record a new encryption technique describing an individual encryption technique in the host PC and a corresponding user ID area in the MFP, from the host PC. Accordingly, it becomes possible to perform encryption and decryption using an original, new encryption technique. Accordingly, even when another user obtains the encrypted print job, it is impossible to decrypt the same.

Referring to FIG. 7, when the user registers a new encryption technique Tn+1, a request is issued to printer driver 401 in the host PC for registration of the encryption technique (see (1) in the figure).

Encrypting processor 403 in the host PC registers the new encryption technique Tn+1 with an encryption technique ID (here, “n+1”) attached thereto, and outputs the ID (see (2) in the figure).

Next, from the host PC to the MFP, a user ID (here it is assumed that each host PC has a user ID), the new encryption technique Tn+1 and the encryption technique ID are transmitted (see (3) in the figure).

Printing processor 451 of the MFP registers the new encryption technique with the encryption technique ID attached, with the group of encryption techniques corresponding to the user ID (see (4) in the figure).

In this manner, it becomes possible to use a different encryption technique for a different user.

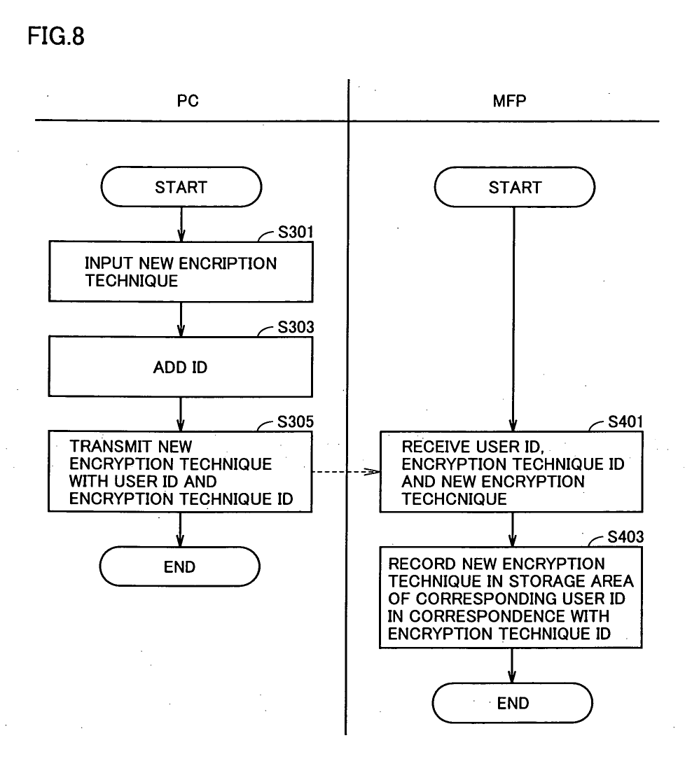

FIG. 8 is a flow chart representing a process performed by the host PC and the MFP for registering the new encryption technique shown in FIG. 7.

Referring to the figure, when a new encryption technique is input to host PC in step S301, an ID is attached thereto in step S303.

In step S305, the new encryption technique is transmitted together with the user ID of the host PC and the encryption technique ID, to the MFP.

In the MFP, when the user ID, the encryption technique ID and the new encryption technique are received in step S401, the new encryption technique is recorded in correspondence with the encryption technique ID in a corresponding user ID storage in step S403.

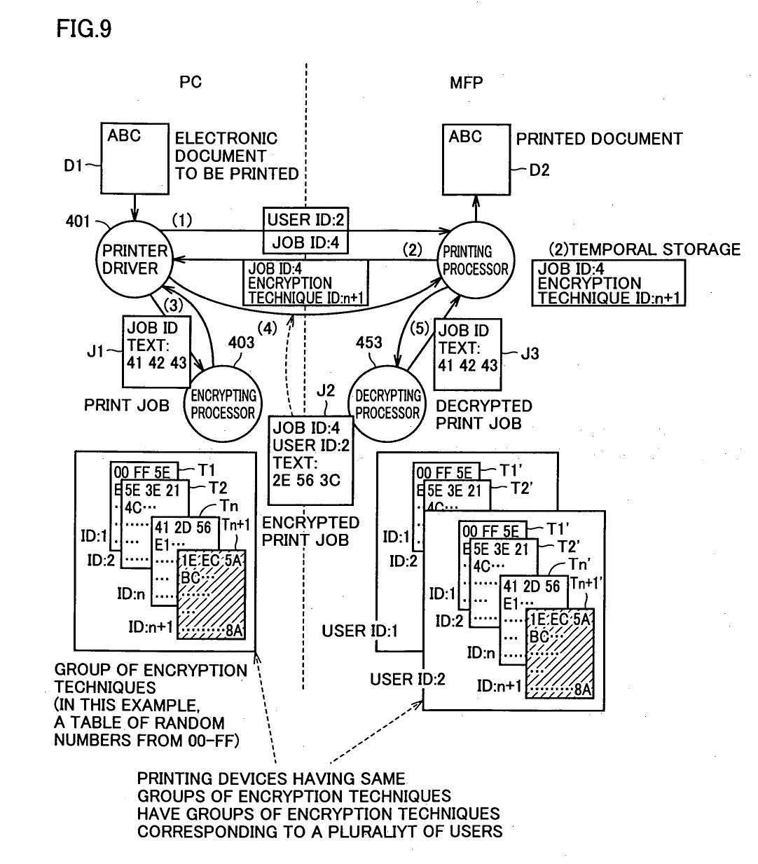

FIG. 9 represents a process performed in the host PC and the MFP at the time of printing in accordance with the present embodiment.

Referring to the figure, in the present embodiment, encryption is performed in the similar manner as shown in FIG. 4, and it is noted that in the process of (1) in the figure, the user ID is transmitted in addition to the job ID to the MFP. At this time, importance of the print job is also set by the user, which is also transmitted simultaneously. If it is an important print job, the encryption technique Tn+1 that has been newly registered in the process of FIG. 7 is selected among the encryption techniques for user ID:2, in the process (2) of selecting encryption technique. In (3), the print job is encrypted in accordance with the technique Tn+1 at the encryptor. Thus, confidentiality of the job can be enhanced.

In the process of (4), the user ID is added to the encrypted print job J2, and transmitted to the MFP.

At the time of decryption of process (5), the encryption technique is obtained from the group of encryption techniques corresponding to the user ID, and decryption is done accordingly.

In this manner, it is possible in the present embodiment to use a different group of encryption techniques for a different user ID, and hence data security can further be enhanced.

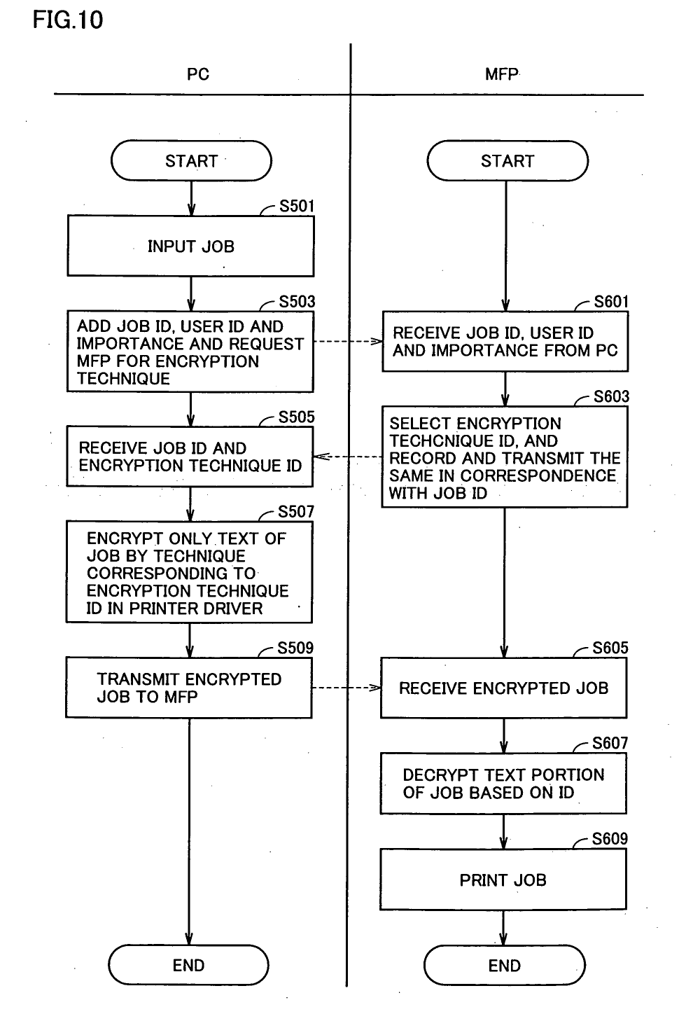

FIG. 10 represents a process performed by the host PC and the MFP in accordance with the present embodiment.

Referring to the figure, in the host PC, when a job is input in step S501, a job ID, a user ID and importance are added thereto (the importance may be added by the user, or it may be automatically added in accordance with the type of the job) in step S503, and the result is transmitted together with a request for encryption technique, to the MFP.

In the MFP, when the job ID, user ID and the importance are received from the host PC in step S601, an encryption technique ID is selected from the group of encryption techniques in consideration of the user ID and the importance, and the selected ID is recorded in correspondence with the job ID and transmitted to the host PC. If the importance is “high”, for example, the encryption technique unique to the user may be selected.

The processes of steps S505 to S509 and S605 to S609 are the same as steps S105 to S109 and S205 to S209 shown in FIG. 6, and therefore, description thereof will not be repeated here.

In the processes shown in FIGS. 9 and 10, it is assumed that the encryption technique is selected by the MFP in consideration of importance. However, it is not limiting, and selection may be made by the PC. Specifically, the encryption technique may be selected by the PC based on the importance, and the selected encryption technique (or information specifying the technique such as the ID) may be transmitted to the MFP.

Further, in one session of encryption and decryption, a plurality of encryption techniques may be used. For instance, one text portion of a job may be encrypted by encryption technique T1 and another text portion may be encrypted by encryption technique T2 and these portions may be decrypted accordingly.

A program executing the processes shown in the flow charts of the embodiments described above may be provided, or the program may be recorded on a recording medium such as a CD-ROM, a flexible disk, a hard disk, a ROM, a RAM or a memory card to be provided to the user. The program may be downloaded to a device through a communication network such as the Internet.

Although the present invention has been described and illustrated in detail, it is clearly understood that the same is by way of illustration and example only and is not to be taken by way of limitation, the spirit and scope of the present invention being limited only by the terms of the appended claims.

1. A recording medium recording a print job processing program to have a computer execute
an encrypting step of identifying and encrypting a text portion of an input print job; and
a transmission step of transmitting the print job having the text portion encrypted by said encrypting step to an external device.

2. The recording medium recording a print job processing program according to claim 1, to have a computer further execute
a selecting step of selecting one of a plurality of encryption techniques as an encryption technique used in said encrypting step.

3. The recording medium recording a print job processing program according to claim 2,.wherein said selection is done based on a signal input from said external device.

4. A recording medium recording a print job processing program used in a device having a storage area storing an encryption technique common to an encryption technique performed by an external device, to have a computer execute
an input step of inputting a new encryption technique;
a registering step of registering said input new encryption technique in said storage area; and
a transmission step of transmitting said input new encryption technique to said external device so that said input new encryption technique is registered in said external device.

5. The recording medium recording a print job processing program according to claim 4, wherein
a plurality of encryption techniques are registered in said storage area; said program further has the computer execute
an encrypting step of encrypting an input print job by using an encryption technique selected from said plurality of encryption techniques; and
a job transmission step of transmitting the print job encrypted by said encrypting step to said external device.

6. The recording medium recording a print job processing program according to claim 5, wherein
said selection is done based on a signal input from said external device.

7. The recording medium recording a print job processing program according to claim 5, wherein said selection is made based on importance of the print job transmitted in said job transmission step.

8. A printing device, comprising:.
a decryptor identifying a text portion from an input print job and decrypting that text portion; and
a printer printing the print job having the text portion decrypted by said decryptor.

9. The printing device according to claim 8, further comprising a selector selecting one of a plurality of encryption techniques as a decryption technique used by said decryptor.

10. A printing device, comprising:
a receiver receiving a new encryption technique together with a user ID;
a registry registering said received encryption technique as a new encryption technique in correspondence with said user ID;
a selector selecting one of a plurality of registered encryption techniques based on a user ID that corresponds to a print job, when the print job is to be processed;
a decryptor decrypting said print job using said selected encryption technique; and
a printer printing the print job decrypted by said decryptor.

11. The printing device according to claim 10, receiving information related to importance of the print job, and selecting an encryption technique based on the user ID and the information related to importance.

12. A printing system having a computer and a printing device connected to a network, wherein
said computer includes
an allocater allocating a job ID to a print job,
a first transmitter transmitting said job ID to said printing device,
a receiver receiving information identifying an encryption technique transmitted by said printing device, in response to transmission by said first transmitter,
an encryptor selectively encrypting a text portion of said print job in accordance with the received information identifying the encryption technique, and
a second transmitter transmitting said encrypted print job to said printing device; and
said printing device includes
a first receiver receiving the job ID from said computer,
a selector selecting the encryption technique in response to reception by said first receiver,
a transmitter transmitting information identifying said selected encryption technique to said computer,
a second receiver receiving the print job encrypted by said selected encryption technique from the computer, and
a decryptor selectively decrypting the text portion of said received encrypted print job by said selected encryption technique.

13. The printing system according to claim 12, wherein
said computer further includes
a storage capable of storing a plurality of encryption techniques,
an encryption technique inputting section for inputting a new encryption technique,
a registry registering said input new encryption technique in said storage, and
an encryption technique transmitter transmitting said input new encryption technique together with an ID to said printing device; and
said printing device includes
a storage capable of storing a plurality of encryption techniques,
an encryption technique receiver receiving said transmitted encryption technique, and
a registry registering said received encryption technique in said storage based on the ID.

14. A method of processing a print job transmitting printdata to an external device, comprising
an encryption step of identifying a text portion from an input print job and encrypting the text portion; and
a transmission step of transmitting the print job having the text portion encrypted in said encryption step to the external device.

15. A method of processing a print job used in a device having a storage area storing an encryption technique common to an encryption technique performed by an external device, comprising
an input step of inputting a new encryption technique,
a registering step of registering said input new encryption technique to said storage area; and
a transmission step of transmitting said input new encryption technique to said external device so as to register said input new encryption technique with said external device.
